(19) United States
(12) Patent Application Publication
(10) Pub. No.: US 2013/0074778 A1
(43) Pub. Date: Mar. 28, 2013

(54) LINKING STRUCTURES

(71) Applicant: Lawrence I. Wechsler, Great Neck, NY (US)

(72) Inventor: Lawrence I. Wechsler, Great Neck, NY (US)

(21) Appl. No.: 13/532,079

(22) Filed: Jun. 25, 2012

Related U.S. Application Data
(60) Provisional application No. 61/500,558, filed on Jun. 23, 2011.

(51) Int. Cl. A01K 11/00

(52) U.S. Cl. CPC A01K 15/026
USPC 119/709

(57) ABSTRACT

A linking unit, advantageously made of rubber or elastomeric resin or an edibly consumable material, includes at least a portion which is looped in an encircling configuration, but which includes a discontinuity for allowing the loop to be linked with an enclosed structure of another element. The unit link when assembled as an interconnected structure will find particularly advantageous utility as a pet toy.

### CROSS REFERENCE TO RELATED APPLICATIONS

This application claims the benefit of U.S. Provisional Application No. 61/500,558 filed Jun. 23, 2011 entitled LINKING TOY.

### BACKGROUND OF THE INVENTION

The present invention relates to a linking structure for pets, and more particularly to a unit link which can be mutually connected to another unit link or other linkable unit to allow the user to create various linked structures for use as a pet chew toy or treat novelty.

Many building toys have been proposed which allow a user to be entertained by creating various structures from individual construction elements. One well known example is the LEGO building set, which contains various interconnectable pieces that can be used to produce elaborate assemblies.

While many such toys have been proposed, there has heretofore been no suggestion for a toy or pet treat which involves an interlinking of chain elements to create various useful configurations.

While a toy is known which includes interconnected rings (chain links) comprised of rubber, and designed as a dog chew toy, the links are permanently interlinked, and therefore no manner of altering a number of linked rings, or a configuration of an assembly, is suggested.

An object of the invention is to provide a unit structure including at least a link portion which can be interlinked with other elements, and which would be useful as a pet toy or treat, or for providing entertainment to people.

### SUMMARY OF THE INVENTION

In accordance with this and other objects of the invention, there is provided a linking unit which includes at least a portion which is looped in an encircling configuration, but which includes a discontinuity (gap or opening) for allowing the loop to be linked with an enclosed structure of another element. Each link is optionally comprised of rubber or elastomeric resin. Alternatively, the links could optionally be comprised of a consumable product, such as for example corn starch based resin, rawhide or compressed rawhide scraps, etc, currently which are commonly used in producing treat bones and chews in the pet field.

In a particularly advantageous embodiment, the unit link will include an overlapping section in which terminal ends of the looped structure overlap in opposed longitudinal directions, so that another looped structure can be linked with the unit link either by a sliding motion or by elastically spreading apart the overlapping end sections where an elastically yieldable material is used.

By selective linking, various configurations according to respective embodiments of the invention are possible. While a unit link is mutually interconnectable with a like unit link, there is no requirement that like-shaped loops be used for an assembly. This allows increased versatility in creating assemblies. For example, when adapted to use as a pet toy or pet consumable, a series of interconnected links could be hooked, for example, at an end of the chain, to a plush toy having a loop of fabric or the like, or to other dissimilarly configured links.

The invention will find particular application in the field of pet toys. The above, and other objects, features and advantages of the present invention will become apparent from the following description read in conjunction with the accompanying drawings.

### BRIEF DESCRIPTION OF THE DRAWINGS

FIG. 1 is a plan view of an embodiment of a unit link in accordance with an embodiment of the invention;

FIG. 2 is perspective view of the unit link of FIG. 1;

FIG. 3 is a depiction of an assembled linear chain utilizing three of the unit links of FIGS. 1 and 2;

FIG. 4 is a depiction showing a nine link chain loop assembly;

FIG. 5 is a depiction of another assembly example;

FIG. 6 is an explanatory illustration of a preferred method of interlinking; and

FIG. 7 is a cross-section view of the respective end portions aligned for slidable interlinking.

### DETAILED DESCRIPTION OF THE PREFERRED EMBODIMENT

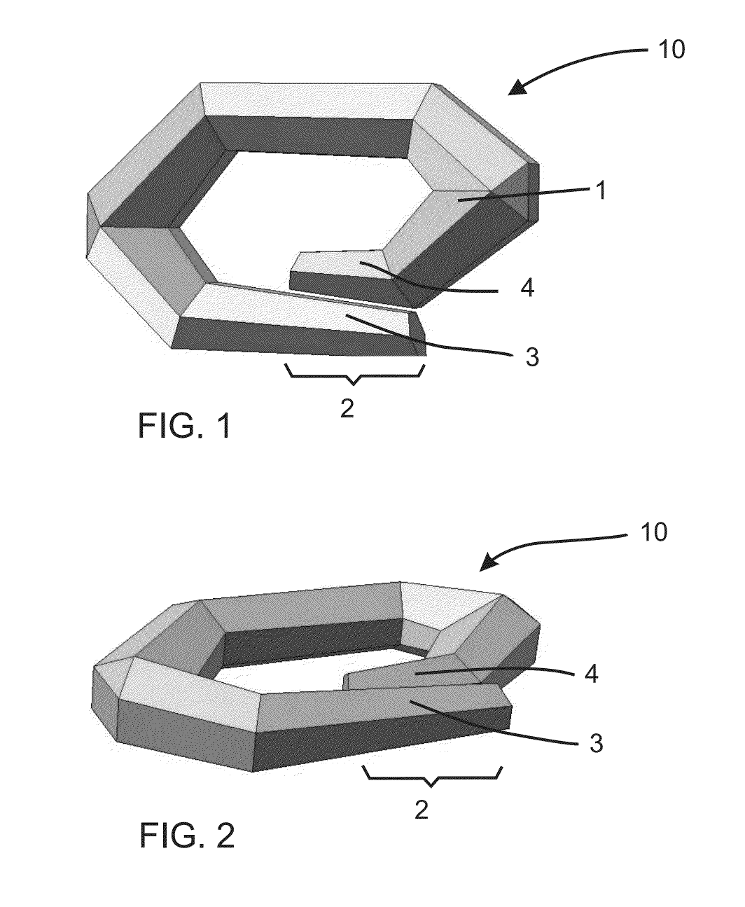

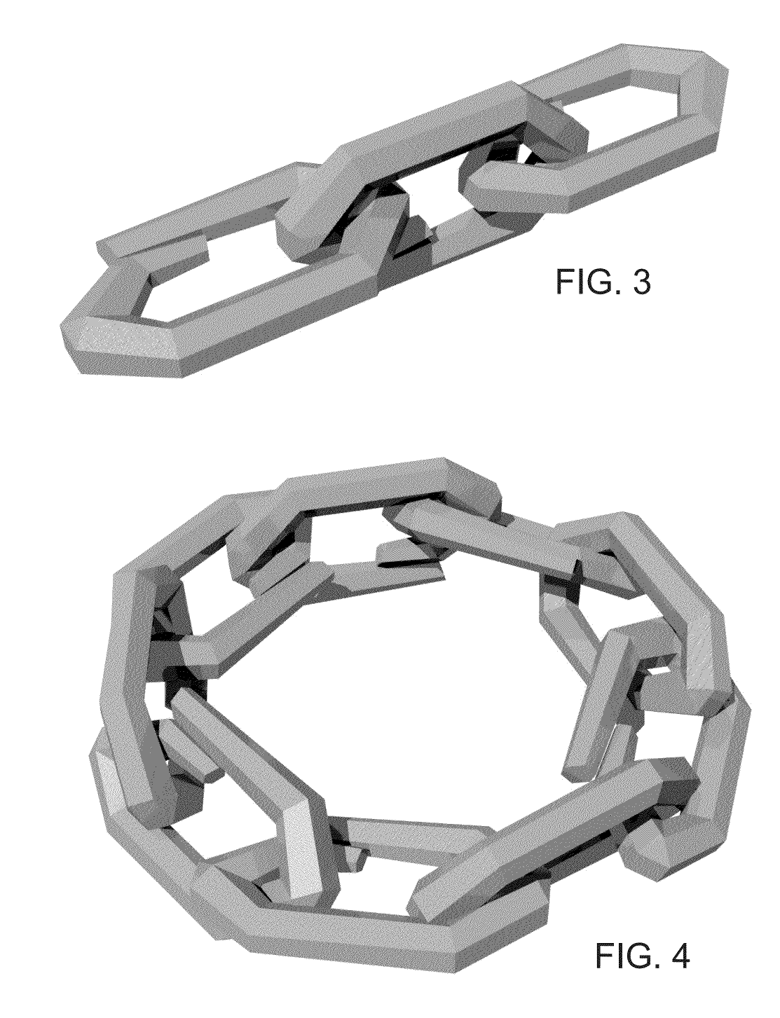

Referring now to the figures, and in particular FIGS. 1 and 2, a unit link is shown generally at 10 which includes a link body 1. The link body 1 is molded or fabricated by other suitable known practice so as to have generally encircling shape, and having two terminal ends which are not connected. The material will advantageously demonstrate elastomeric characteristics, and may, for example, comprise natural or synthetic rubber or elastomer. While the ends can simply be oriented in simple abutment or as having a gap between confronting end surfaces, in general accordance with the particularly advantageous embodiment depicted, the link body 1 optionally includes an overlapping region 2, in which terminal end portions 3, 4 overlap one another in opposed directions. This optional feature inhibits undesirable separation of the unit links. While not shown, additional precaution against unintentional detachment can be provided by providing a detent in one of the end portions 3, 4 and a corresponding engagement protrusion in a remaining one of the end portions 3, 4.

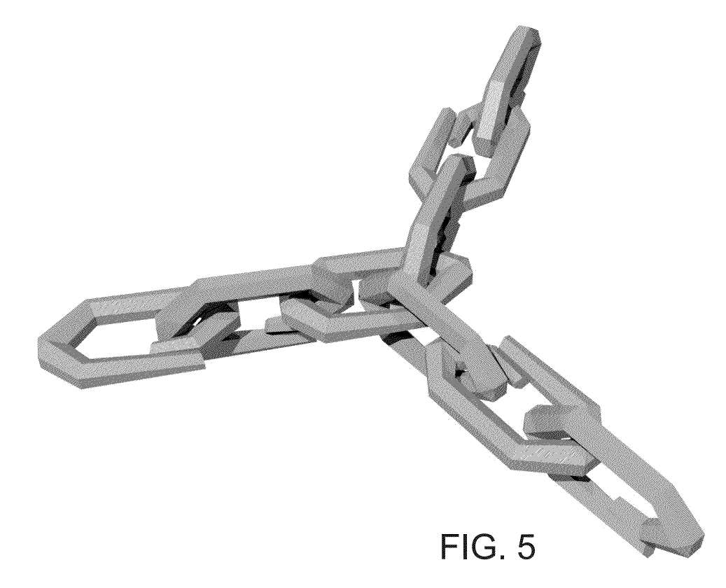

Various structures producible by the unit link of FIGS. 1 and 2 are depicted in FIGS. 3-5, and which are believed to be self explanatory.

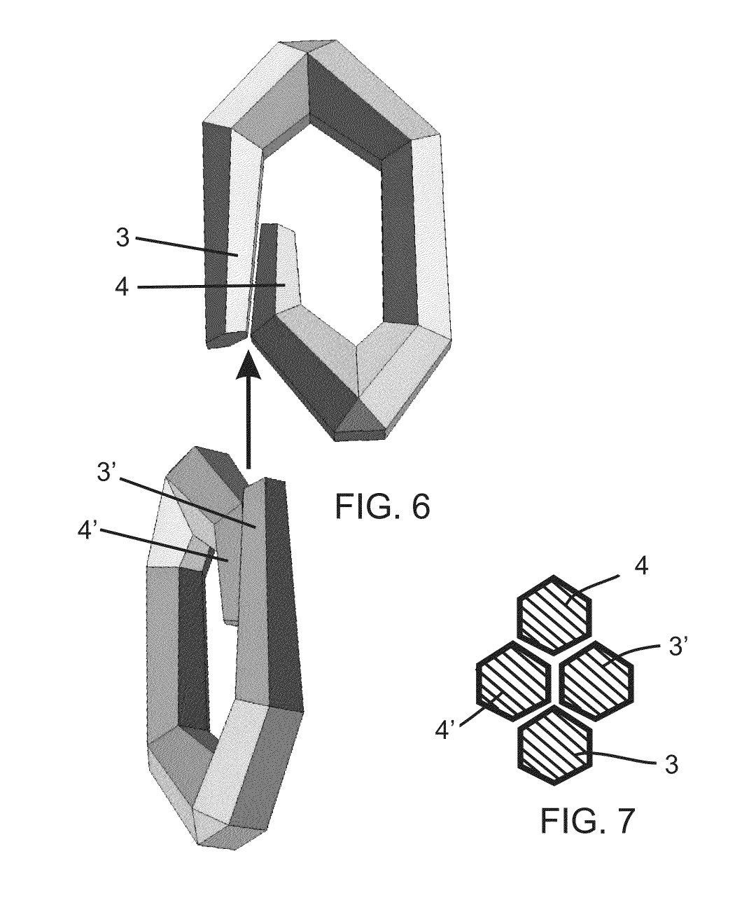

While the end portion 3, 4 can simply be spread apart to be interlinked, and then allowed to return to the unstressed position shown in the figures, an advantageous manner of interlinking is illustrated in FIG. 6. As shown therein, to interconnect the unit links, one unit link 10 is oriented roughly orthogonally to another unit link 10′, which allows sliding of one unit link into the other. FIG. 7 shows in cross-section how the end portions 3, 4 and 3′, 4′ mutually slide. It is noted, that although shown in the example as being hexagonal in cross-section, any other cross-sectional shape is also feasible. The depicted approach allows even rigid links to be mutually inter-linked. As such, the links can, in accordance with an embodiment of the invention, be advantageously comprised of an edibly consumable treat material, such as, for example, compressed rawhide or rawhide slurry, molded starch-based material, baked biscuit material, etc. When used as a novely directed to human use, the links can be sugar or flour based, for example, to produce hard candy or pretzel links, etc.

It is noted that, while a faceted link design example is depicted for illustrative purposes, a diverse range of link shapes and configurations are contemplated within the scope of the invention. For example, the links can include decorative portions to provide a unique appearance when linked, and can include, for example, structure resembling a cut gemstone, a twisted pretzel, a hotdog, or other recognizable product ordinarily provided in a linked form, for enhanced novelty appeal.

In practice, the links can be provided to consumers in an assembled interlinked form or separately in the nature of a kit, in which at least two detached links are provided for later assembly by the consumer.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention.

What is claimed is:

1. A unit link, comprising:
a link body comprised of an elastomeric material or an edibly consumable material, said link body including at least a looped portion having a terminal end which is discontinuous with another surface of the link body.

2. A unit link according to claim 1, wherein the link body includes two terminal ends oriented in simple abutment having a gap between confronting end surfaces.

3. A unit link according to claim 1, wherein the link body includes two terminal ends, said link body having an overlapping region in which terminal end portions adjacent to the two terminal ends overlap one another in opposed directions.

4. A kit for assembly by a consumer, comprising at least two detached unit links, each of said two detached unit links being comprised of an elastomeric material or an edibly consumable material and comprising a link body including at least a looped portion having a terminal end which is discontinuous with another surface of the link body.

5. A method of providing entertainment, comprising:
providing at least two detached unit links which are interconnectable with one another of an other article, at least one of said unit links being comprised of an elastomeric material or an edibly consumable material; and
interlinking the at least two detached unit links with one another or with said other article.
